(19) United States
(12) Patent Application Publication
(10) Pub. No.: US 2018/0309686 A1
(43) Pub. Date: Oct. 25, 2018

(54) REDUCING RATE LIMITS OF RATE LIMITERS

(71) Applicant: HEWLETT PACKARD ENTERPRISE DEVELOPMENT LP, Houston, TX (US)

(72) Inventor: Steven Roth, Palo Alto, CA (US)

(21) Appl. No.: 15/494,540

(22) Filed: Apr. 23, 2017

(51) Int. Cl. H04L 12/825; H04L 12/26

(52) U.S. Cl. CPC H04L 47/25; H04L 43/16; H04L 43/0894

(57) ABSTRACT

Example implementations relate to reducing a rate limit. An example implementation includes processing resource requests of a first priority level and resource requests of a second priority level. The rate of resource requests of the first priority level processed may be limited to a first rate limit and the rate of resource requests of the second priority level processed may be limited to a second rate limit. A resource request load that exceeds a maximum resource request threshold may be detected. The second rate limit of the second rate limiter may be reduced such that the resource request load no longer exceeds the maximum resource request threshold.

### BACKGROUND

Data systems continue to increase in scale and may include a multitude of servers providing various services. Large scale data systems may have finite computational resources and may become overloaded due to a request rate spike, a contention for computational resources, and/or component failures. Circuit breakers may be provided for combatting overload due to component failures of a system. One method for combatting overload due to resource contention may include queuing requests for sequential resolution.

### BRIEF DESCRIPTION OF THE DRAWINGS

Certain examples are described in the following detailed description and in reference to the drawings, in which:

FIG. 1 is a block diagram illustrating an example system for reducing the rate limit of a rate limiter.

FIG. 2 is a flowchart illustrating an example method for reducing the rate limit of a rate limiter.

FIG. 3 is a flowchart illustrating an example method for logging a change in the rate limit of a rate limiter.

FIG. 4 is a block diagram illustrating an example non-transitory computer readable storage medium for reducing the rate limit of a rate limiter.

### DETAILED DESCRIPTION OF SPECIFIC EXAMPLES

A system may become overloaded due to a contention for resources within the system. For example, a system may include various services, and requests to perform various functions enabled by the services may be initiated, e.g. by a user. Each initiated request may demand resources from the system, and the system may be overloaded where the resources demanded by requests at a given time exceed the capacity of the system. This may occur where demanded resources from resource requests exceeds the resources available to the system. For example, a virtual machine running on an underprovisioned virtual machine host may starve the virtual machine host of resources.

To prevent system overload, rate limiters may be implemented to limit the rate of requests a system processes at a given time. A rate limiter may take the form of processor-executable instructions stored on a non-transitory machine readable storage medium, and the processor-executable instructions may, upon execution, cause hardware to limit the rate at which requests are processed. The rate limiter may include hardware and may include a processing resource to execute programming instructions. A processing resource may include various numbers of processors with a single or multiple processing cores, and a processing resource may be implemented through a single processor or multi-processor architecture.

A rate limiter may include a rate limit capping the rate at which requests may be queued and/or processed. The rate limit may be fixed, or the rate limit may be variable such that the rate limit changes based on a criterion. For example, the rate limit may be increased where additional resources become available to the system, or the rate limit may be decreased where system resources are removed, become noncompliant, fail, or are otherwise unavailable to the system. A rate limiter may limit any number of different types of rates with respect to resource requests. For example, a rate limiter may temporally limit the number of resource requests, such that a specified number of resources may be processed within a given time frame, e.g. five resources per second. In another example, a rate limiter may limit the number of resource requests that are processed concurrently, such that a specified number of resources may be processed at a given time.

In an example, a rate limit may be reduced where greater demand is placed on the system for processing, e.g. during times of excessive load on the system. Similarly, a rate limit may be increased where the overall load on the system decreases. In an example, a rate limit may be reduced where a service utilizing limited system resources, and having a greater priority than a service requested by a resource request, is identified. In some examples, a rate limit may be increased where the rate requests being limited are assigned a higher priority than a different process demanding system resources.

A rate limit monitor may be implemented to change the rate limit of a rate limiter. The rate limit monitor may be in communication with multiple rate limiters in a system, and may change the rate limit of any number of the rate limiters. In an example, a rate limit monitor may increase or decrease the rate limit of a first rate limiter by a first amount, and increase or decrease the rate limit of a second rate limiter by a second amount. In an example, the rate limit monitor may change the first rate limit of the first rate limiter and hold the second rate limit of the second rate limiter constant. In an example, the rate limit monitor may increase or decrease the second rate limit of the second rate limiter by an amount dependent on an increase or decrease of the first rate limit of the first rate limiter. Instances of such a dependency will be described in further detail herein.

The invention described herein relates to the improvement of large-scale multiprocessing systems. Large-scale multiprocessing systems may utilize a shared memory resource and/or message passing by multiple processors to enable parallel execution of multiple processes. The implementation of a rate limit monitor may improve the functionality of a computing system having shared resources, such as a multiprocessing system, by ensuring that the computing system runs efficiently, does not exhaust computational resources, and/or does not become overloaded. The rate limit monitor may also improve a computing system by improving the management of resource requests by the system. For instance, the rate limit monitor may ensure that resource requests of higher priority are processed at a greater rate than resource requests of a lower priority while still ensuring that some resource requests of lower priority are processed.

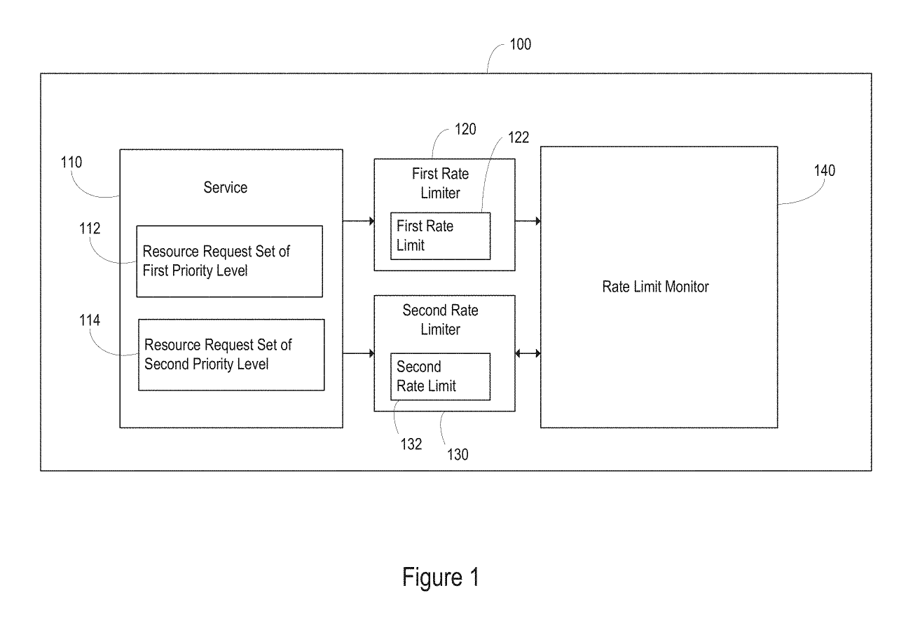

FIG. 1 is a block diagram illustrating an example system 100 for changing the rate limit of a rate limiter. The system may include a service 110 to perform various computational operations. In an example, system resources may be utilized to carry out a computational operation provided by service 110. In an example, a service may perform multiple computational operations of varying degrees of priority. For example, a first computational operation of a first priority may be performed from a first resource request, and a second computational operation of a second priority may be performed from a second resource request. While resource requests of one service are illustrated in FIG. 1, for purposes of clarity and conciseness, resource requests of any number of services may be implemented.

In an example, a resource request may be classified according to the priority of the computational operation being requested. Specifically, service 110 may intake a set of resource requests of a first priority level 112 and a set of resource requests of a second priority level 114. In an example, the resource requests of the first priority level 112 and the resource requests of the second priority level 114 make up the resource requests received by service 110. While a resource request set of a first priority level and a resource request set of a second priority level are illustrated in FIG. 1, resource requests may be classified into any number of different priority levels.

The rate at which requests are performed may be limited to prevent rate request spikes from overloading a system. Resource requests may also be limited to prevent resource contention and/or to ensure that resource requests consume a predetermined amount of system resources at a given time. In an example, a rate limiter may limit the rate at which resource requests are performed. For instance, rate requests may not exceed a rate limit of the rate limiter. In an example, rate requests may be queued such that rate requests are processed in the order at which the requests were made. In another example, requests that exceed the rate limit of the rate limiter may be delayed, such that excess resource requests are processed after a predetermined wait time or a time at which more system resources are available. In yet another example, resource requests that exceed the rate limit of the rate limiter may be aborted.

Any number of rate limiters may be utilized to limit the rate of requests performed. Example FIG. 1 illustrates two such rate limiters, including first rate limiter 120 and second rate limiter 130 to limit the rate of requests received by service 110. First rate limiter 120 includes an example first rate limit 122 and second rate limiter 130 includes an example second rate limit 132. In an example, resource requests may be categorized according to a criterion and a rate limit of a rate limiter may be applied to a resource request category.

In an example, resource requests may be categorized according to priority level and a rate limit of a rate limiter may be applied to resource requests having a corresponding priority level. For example, first rate limit 122 of first rate limiter 120 may limit the rate of resource requests from a set of resource requests of a first priority level, such as resource request set 112. Similarly, second rate limit 132 of second rate limiter 130 may limit the rate of resource requests from a set of resource requests of a second priority level, such as resource request set 114. In an example, the second priority level may be of lower priority than the first priority level.

In an example, the criterion for which a resource request may be categorized may be an associated service from which the resource request is generated. For instance, resource requests for a first service may be categorized into a first set and resource request for a second service may be categorized into a second set. A first rate limit of a first rate limiter may limit the rate of requests from a first service and a second rate limit of a second rate limiter may limit the rate of requests from a second service. Accordingly, rate requests may be categorized such that different rate limits may be applied to rate requests from different categories.

A rate limit monitor may monitor a resource request load and may dynamically adjust a rate limit of a rate limiter to ensure that the resource request load does not exceed a threshold. A resource request load may be the amount of resources requested by any resource requests at a given time. For instance, a threshold amount of computational resources may be allocated to performing resource requests for one or more services. The rate limit monitor may dynamically adjust one or more rate limits of one or more rate limit monitors such that the threshold amount of computational resources is not exceeded. In an example, hysteresis may be incorporated in the rate limit monitor such that the threshold amount of computational resources is not exceeded for longer than a predetermined amount of time.

The resource request load may be measured by the rate limit monitor using a variety of metrics, and may refer to reported statistics of an operating system, e.g. the average load of the system, input/output bandwidths of the system, paging rates of the system, etc. The resource request load may also refer to reported statistics of a hypervisor of the system, such as CPU provisioning rates, current workload size, available ram, etc. A resource request load may also be measured by the response time of a system to a resource request. For instance, a greater response time of a system may indicate that the system is overloaded with a large resource request load.

Rate limit monitor 140 is an illustrated example of a rate limit monitor for monitoring a resource request load. Rate limit monitor 140 may take the form of processor-executable instructions stored on a non-transitory machine readable storage medium, and the processor-executable instructions may, upon execution, cause hardware to perform any of the rate limit regulating aspects described herein. The rate limit monitor may include hardware and may include a processing resource to execute programming instructions. A processing resource may include various numbers of processors with a single or multiple processing cores, and a processing resource may be implemented through a single processor or multi-processor architecture.

Upon detecting that the resource request load exceeds a first load threshold, rate limit monitor 140 may increase and/or reduce first rate limit 122 of first rate limiter 120. Similarly, rate limit monitor 140 may increase and/or reduce the second rate limit 132 of second rate limiter 130 upon detecting that the resource request load exceeds a first load threshold. In an example, first rate limit 122 of first rate limiter 120 and/or second rate limit 132 of second rate limiter 130 may be reduced such that the system load no longer exceeds the first load threshold.

In an example, a rate limit associated with resource requests categorized as having a lower priority may be reduced to a greater degree than a rate limit associated with resource requests having a greater priority. For example, the rate of resource requests from the set of resource requests of the first priority level 112 may be limited to first rate limit 122. Similarly, the rate of resource requests from the set of resource requests of the second priority level 114 may be limited to second rate limit 132. The resource request set of the first priority level 112 may include resource requests of a higher priority level than the resource request set of the second priority level 114. Rate limit monitor 140 may reduce second rate limit 132 to a greater degree than first rate limit 122 to ensure that the resource request load does not exceed the first load threshold. In an example, rate limit monitor 140 reduces the second rate limit 132 but does not reduce the first rate limit 122 where rate limit monitor 140 is able to bring the resource request load below the first load threshold by reducing second rate limit 132.

In an example, a policy may be implemented such that rate limit monitor 140 reduces second rate limit 132 by an amount dependent upon the amount first rate limit 122 is reduced. For instance, first rate limit 122 of first rate limiter 120 may be reduced by a first percentage and second rate limit 132 of second rate limiter 130 may be reduced by a second percentage dependent on the reduction to the first percentage. In one example, the first percentage may be a fraction of the second percentage. For example, second rate limit 132 of second rate limiter 130 may be reduced by a fraction of the amount first rate limit 122 of first rate limiter 120 is reduced. Accordingly, the reduction to the second rate limit may be directly proportional to the reduction to the first rate limit.

In a further example, a policy may be implemented such that the rate limit associated with resource requests of a lower priority may not be reduced beyond a non-zero threshold. For instance, rate limit monitor 140 may reduce second rate limit 132 of second rate limiter 130 up to a first percentage threshold such that a non-zero rate of resource requests of the second priority level 114 are processed. In an example, where second rate limit 132 is reduced by rate limit monitor 140 to the first percentage threshold, rate limit monitor 140 may reduce first rate limit 122 of first rate limiter 120 such that the resource request load no longer exceeds the first load threshold.

For example, rate limiter 120 may have a first rate limit 122 of eight resource requests per second, and second rate limiter 130 may have a second rate limit 132 of four resource requests per second. For purposes of this explanation, second rate limit 132 may be associated with rate requests of a lower priority than rate requests of the first rate limit. Where a resource request load is exceeded, rate limit monitor 140 may reduce the second rate limit 132 to two resource requests per second, a rate limit reduction of 50%, such that the resource request load is no longer exceeded. In this way, the rate limit of rate requests of higher priority may remain constant while rate requests of a lower priority are reduced such that the resource request load is not exceeded. Second rate limit 132 may have a first percentage threshold, e.g. a 75% reduction. Where rate limit monitor 140 reduces the second rate limit 132 to the first percentage threshold, e.g. one request per second, rate limit monitor 140 may reduce the first rate limit 122 of first rate limiter 120 such that the resource request load is no longer exceeded while holding the second rate limit constant at the first percentage threshold. Although the example above refers to a rate limit that limits the number of resource requests that may be processed within a given time frame, other types of rate limits may be utilized, such as a rate limit that limits the number of resource requests that are processed concurrently.

In an example, first rate limit 122 of first rate limiter 120 may have a second percentage threshold that takes priority over the first percentage threshold. For instance, where rate limit monitor 140 reduces first rate limit 122 to the second percentage threshold, but despite the reduction the resource request load still exceeds the first load threshold, rate limit monitor 140 may reduce second rate limit 132 beyond the first percentage threshold. In other words, rate limit monitor 140 may prioritize reducing second rate limit 132 beyond the first percentage threshold over reducing first rate limit 122 beyond the second percentage threshold.

In an example, a rate limit of a rate limiter, e.g. first rate limit 122 of first rate limiter 120 or second rate limit 132 of second rate limiter 130, may be logged and any changes to the rate limit of the rate limiter may be recorded. In an example, any reduction or increase to first rate limit 122 or second rate limit 132 may be logged. A rate limit of a rate limiter may be reduced or increased responsive to the rate limit monitor detecting that a resource request load is more than or less than a resource request threshold. By logging the reduction or increase to the rate limit of the rate limiter, insight into system usage patterns may be gleamed. For instance, it may be determined that the rate limit is decreased during times at which certain services are available and an increase in resource requests related to those services are generated.

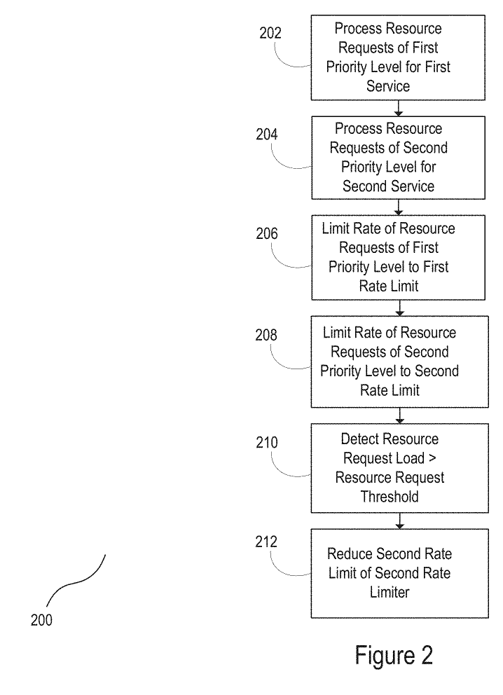

FIG. 2 is a flowchart illustrating a method 200 for reducing the rate limit of a rate limiter. The method 200 may be implemented in the form of executable instructions stored on a computer-readable medium or in the form of electronic circuitry. The sequence of operations described in connection with FIG. 2 is not intended to be limiting, and an implementation consistent with the example of FIG. 2 may be performed in a different order than the example illustrated. Additionally, operations may be added or removed from the method 200.

Execution of method 200 is described with reference to system 100. However, any other device, hardware-programming combination, or other suitable computing system may implement or execute any of the steps of method 200. As examples, method 200 may be implemented in the form of executable instructions stored on a machine-readable storage medium or in the form of electronic circuitry.

In implementing or performing method 200, resource requests of a first priority level, e.g. resource request set 112, may be processed at block 202. Similarly, resource requests of a second priority level, e.g. resource request set 114, may be processed at block 204. In an example, requests for resources offered by one or more services are processed. For example, requests for resources of a first priority level and/or a second priority level may be offered by a first and second service. In some examples, resource requests are prioritized according to the service from which the resource request was generated. However, resource request prioritization may not be dependent upon the service from which the resource request was generated and any number of criterion may be used to determine the prioritization of a resource request.

At block 206, a rate of resource requests may be limited to a first rate limit and, at block 208, a rate of resource requests may be limited to a second rate limit. Specifically, resource requests of the first priority level may be limited to a first rate limit, e.g. first rate limit 122, and resource requests of the second priority level may be limited to a second rate limit, e.g. second rate limit 132. In an example, the resource requests of the first priority level may be limited by a first rate limiter and/or the resource requests of the second priority level may be limited by a second rate limiter, e.g. first rate limiter 120, or second rate limiter 130 respectively.

At block 210, a resource request load is detected to be more than a resource request threshold. In an example, the resource request threshold may be a function of available computational resources for processing the resource requests of the first and second priority level. For instance, the resource request threshold may be a maximum resource request threshold and may be, for example, a predetermined amount of computational resources allocated for processing resource requests. The resource request load may be the computational resources the system would exhaust at a given time in order to process the resource requests. Where the resource request load is detected to exceed the maximum resource request threshold, a greater amount of resources may be exhausted to process the resource requests than was allocated. In an example, a rate limit monitor, e.g. rate limit monitor 140, may detect whether the resource request load exceeds the maximum resource request threshold.

At block 212, the second rate limit of the second rate limiter may be dynamically reduced such that the resource request load no longer exceeds the maximum resource request threshold. In an example, a rate limit monitor, e.g. rate limit monitor 140, may reduce the second rate limit of the second rate limiter. In an example, the second rate limit, e.g. second rate limit 132, of the second rate limiter, e.g. second rate limiter 130, may limit the rate of resource requests from a set of resource requests of a second priority level, e.g. resource request set 114. In this way, the rate at which resource requests of a second priority level are processed may be limited to a greater degree than the rate at which resource requests of a first priority level are processed.

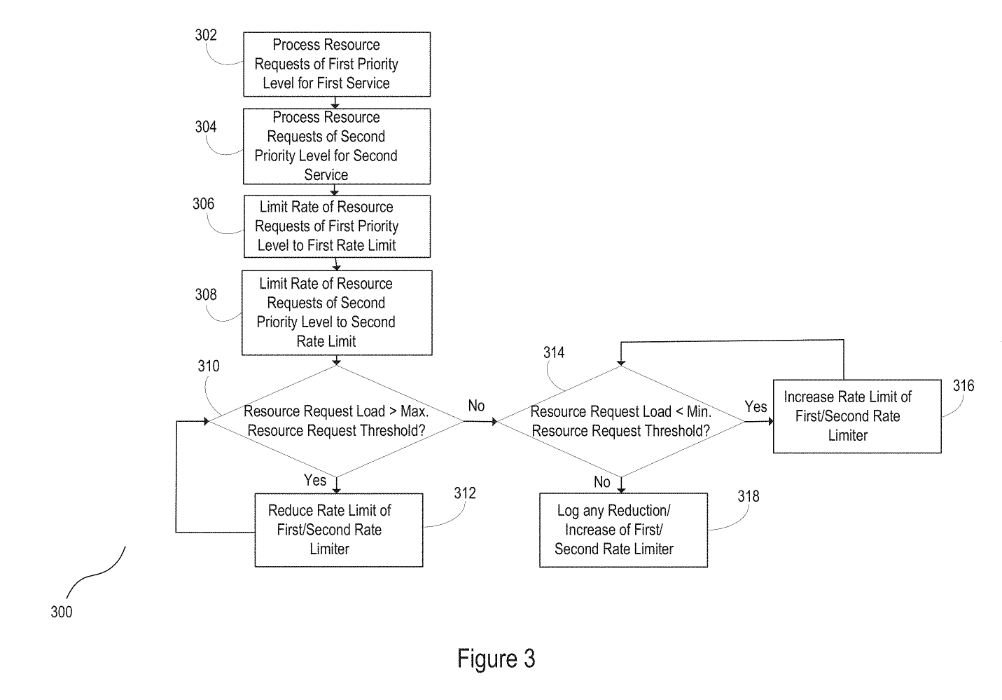

FIG. 3 is an additional flowchart illustrating an example method 300 for logging a change in the rate limit of a rate limiter. The method 300 may be implemented in the form of executable instructions stored on a computer-readable medium or in the form of electronic circuitry. The sequence of operations described in connection with FIG. 3 is not intended to be limiting, and an implementation consistent with the example of FIG. 3 may be performed in a different order than the example illustrated. Additionally, operations may be added or removed from the method 300.

Blocks represented within FIG. 3 may be described with reference to example blocks of FIG. 2. Specifically, blocks 302-308 may be implemented as described in blocks 202-208 as mentioned above. At block 302, a resource request of a first priority level may be processed, and at block 304, a resource request of a second priority level may be processed. At block 306, the rate of resource requests of the first priority level processed may be limited to a first rate limit, and at block 308, the rate of resource requests of the second priority level processed may be limited to a second rate limit.

The rate limit of a rate limit monitor may be dynamically increased. At block 310, it is determined whether a resource request load exceeds a resource request threshold, such as a maximum resource request threshold. In an example, the maximum resource request threshold may be a function of available computational resources for processing the resource requests of the first and second priority level. Where the resource request load is determined to exceed the resource request threshold, the first and/or second rate limit of the first and/or second rate limiter respectively may be dynamically reduced. At block 312, the first and/or second rate limit may be reduced such that the resource request load no longer exceeds the maximum resource request threshold, followed by a return to block 310.

Where the resource request load is determined to be less than a maximum resource request threshold, it may be determined at block 314 whether the resource request load is less than a minimum resource request threshold. The resource request load being less than the minimum resource request threshold may indicate that more computational resources are expendable and/or available to process resource requests. Therefore, the first and/or second rate limit may be increased, e.g. by rate limit monitor 140, and in an example, is increased such that the resource request load exceeds the minimum resource request threshold. In an example, the first rate limit may be increased by a first amount, and the second rate limit may be increased by a second amount less than and/or greater than the first amount such that the resource request load exceeds the minimum resource request threshold.

In an example, a determination at block 314 that the resource request load is less than a minimum resource request threshold leads to an increase of the first and/or second rate limit of the first and/or second rate limiter respectively. Specifically, at block 316 the first and/or second rate limit is increased followed by a return to block 314. In an example, the first and/or second rate limit of the first rate limiter and/or second rate limiter is increased after a predetermined period of time that the resource request load is less than the minimum resource request threshold. Waiting a predetermined period of time prior to increasing a rate limit may prevent system volatility and may encourage system stabilization.

In an example, a rate limit of a rate limiter may be logged and any changes to the rate limit of the rate limiter may be recorded. At block 318, any reduction or increase to the second rate limit of the second rate limiter may be logged followed by a determination that the resource request load is greater than the minimum resource request threshold. The rate limit of the rate limiter may be reduced or increased responsive to the rate limit monitor detecting that a resource request load is more than or less than a resource request threshold. By logging reductions or increases in the rate limit of the rate limit monitor, system usage patterns may be better understood. For example, anomalous behavior such as resource request spikes or dips may be detected, and trends with regard to the logged data may be tracked and analyzed to better understand system or user behavior.

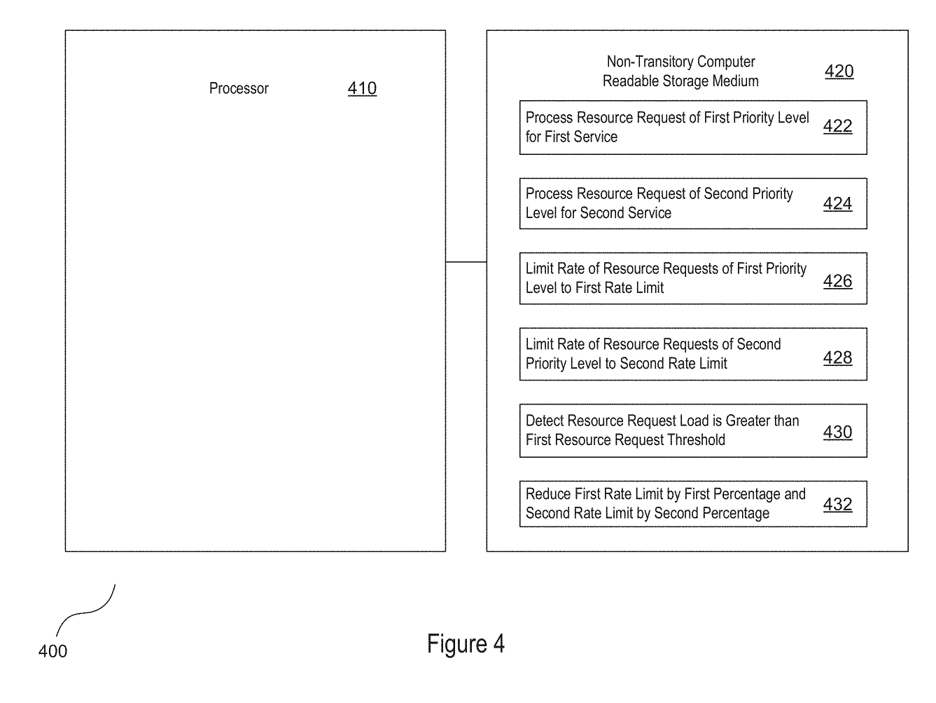

FIG. 4 is a block diagram 400 illustrating an example non-transitory computer readable storage medium 420 for reducing the rate limit of a rate limiter. Non-transitory computer readable storage medium 420 may be coupled to a processor, e.g. processor 410, and may include executable instructions thereon. Instructions 422, when executed, may cause a processor to process resource requests of a first priority level. Similarly, instructions 424, when executed, may cause a processor to process resource requests of a second priority level. In an example, the second priority level is of lower priority than the first priority level such that resource requests of the first priority level are given higher priority than resource requests of the second priority level.

A rate limit may be implemented to limit the rate at which resource requests are processed in a system. Instructions 426 may be provided within non-transitory computer readable storage medium 420 to, when executed, cause a processor to limit the rate of resource requests of a first priority level processed to a first rate limit. Similarly, instructions 428 may be provided to, when executed, cause a processor to limit the rate of resource requests of a second priority level processed to a second rate limit. In an example, the first rate limit may be different than the second rate limit. The rate limits may differ such that a greater rate of resource requests of a higher priority level are processed over resource requests of a lower priority level.

In an example, a reduction to the second rate limit of the second rate limiter may be directly proportional to a reduction to the first rate limit of the first rate limiter. For example, a policy may be implemented such that the second rate limit is reduced by 10% for every 5% reduction of the first rate limit. In an example, the second rate limit of the second rate limiter may be reduced up to a first percentage threshold such that a non-zero rate of resource requests of the second priority level are processed. A first percentage threshold may be implemented with respect to the second rate limit such that the policy will not reduce the second rate limit beyond the first percentage threshold.

For example, the first percentage threshold for the second rate limit may be 30% of the second rate limit. In the example where the second rate limit is reduced by 10% for every 5% reduction of the first rate limit, the second rate limit may be held at 30% even where the first rate limit is reduced by more than 35%. Where the second rate limit has been reduced to the first percentage threshold, the first rate limit of the first rate limiter may be reduced while the second rate limit of the second rate limiter is held constant at the first percentage threshold such that the resource request load no longer exceeds the resource request threshold. For example, the first percentage threshold of the second rate limit may be 30% and the second rate limit may be reduced to 30%. The first rate limit may be reduced such that the resource request load no longer exceeds the resource request threshold without further reducing the second rate limit beyond the 30% first percentage threshold.

In another example, a different policy may be implemented where the second rate limit is reduced to the first percentage threshold. For example, prior to being reduced to the first percentage threshold, a policy may be implemented such that the second rate limit is reduced by 1% for every 2% reduction in the first rate limit. This policy may be implemented up until the second rate limit is reduced to the first percentage threshold, at which point a policy may be implemented such that the second rate limit is reduced by 1% for every 5% reduction in the first rate limit. Accordingly, the rate limit for processing resource requests may be reduced such that the rate limit for lower priority resource requests are reduced more readily, while it is ensured that at least some lower priority resource requests are still processed.

In an example, a second percentage threshold may be implemented with respect to the first rate limit such that the second rate limit is reduced beyond the first percentage threshold where the first rate limit is reduced to a second percentage threshold. For instance, the second rate limit may be reduced up to the first percentage threshold, and the first rate limit may be reduced such that the first percentage threshold of the second rate limit is not exceeded. However, where the first rate limit is reduced up to the second percentage threshold, the second rate limit may be reduced, and in one example, may be reduced beyond the first percentage threshold. In one example, the second rate limit of the second rate limiter is reduced such that the first rate limit of the first rate limiter does not exceed the second percentage threshold. Thus, where limited resource requests may be processed, e.g. where a system is overloaded, higher priority resource requests may be processed even where lower priority resource requests are substantially limited.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A system comprising:
a service to process a first set of resource requests of a first priority level and a second set of resource requests of a second priority level;
a first rate limiter to limit the rate of resource requests of the first priority level by a first rate limit;
a second rate limiter to limit the rate of resource requests of the second priority level by a second rate limit; and
a rate limit monitor to dynamically adjust the second rate limit by:
monitoring a resource request load;
detecting that the resource request load exceeds a first load threshold; and
reducing the second rate limit of the second rate limiter such that the resource request load no longer exceeds the first load threshold.

2. The system of claim 1, wherein the second priority level is of lower priority than the first priority level.

3. The system of claim 1, wherein the rate limit monitor reduces the second rate limit of the second rate limiter up to a first percentage threshold such that a non-zero rate of resource requests of the second priority level are processed.

4. The system of claim 3, wherein the rate limit monitor reduces the first rate limit of the first rate limiter such that the resource request load no longer exceeds the first load threshold where the second rate limit has been reduced to the first percentage threshold.

5. The system of claim 4, wherein the rate limit monitor reduces the second rate limit of the second rate limiter beyond the first percentage threshold where the first rate limit is reduced to a second percentage threshold.

6. The system of claim 1, wherein the rate limit monitor reduces the first rate limit of the first rate limiter such that the first rate limit of the first rate limiter is reduced by a first percentage and the second rate limit of the second rate limiter is reduced by a second percentage that is different than the first percentage.

7. The system of claim 6, wherein the first percentage is a fraction of the second percentage such that the second rate limit is more greatly reduced than the first rate limit.

8. The system of claim 1, wherein the resource request load is monitored by reading reported statistics of the system.

9. The system of claim 8, wherein the reported statistics of the system comprises one of load average, input-output bandwidth, or paging rates.

10. The system of claim 8, wherein the reported statistics of the system comprises one of a provisioning rate or a response time of the system for processing a request.

11. A method comprising:
processing resource requests of a first priority level;
processing resource requests of a second priority level;
limiting the rate of resource requests of the first priority level processed to a first rate limit;
limiting the rate of resource requests of the second priority level processed to a second rate limit;
detecting that a resource request load exceeds a maximum resource request threshold, the maximum resource request threshold being a function of available computational resources for processing the resource requests of the first and second priority level; and
dynamically reducing the second rate limit of the second rate limiter such that the resource request load no longer exceeds the maximum resource request threshold.

12. The method of claim 11, further comprising increasing the second rate limit of the second rate limiter where the resource request load is less than a minimum resource request threshold.

13. The method of claim 12, wherein the second rate limit of the second rate limiter is increased after a predetermined period of time that the resource request load is less than the minimum resource request threshold.

14. The method of claim 12, further comprising logging the reduction or increase of the second rate limit.

15. A non-transitory computer readable medium comprising instructions executable by a processor to:
process resource requests of a first priority level;
process resource requests of a second priority level;
limit the rate of resource requests of the first priority level processed to a first rate limit;
limit the rate of resource requests of the second priority level processed to a second rate limit;
detect that a resource request load is more than a resource request threshold, the resource request threshold being a function of available computational resources for processing the resource requests of the first and second priority level; and
dynamically reduce the first rate limit of the first rate limiter such that the first rate limit of the first rate limiter is reduced by a first percentage and the second rate limit of the second rate limiter is reduced by a second percentage greater than the first percentage.

16. The non-transitory computer readable medium of claim 15, wherein the second priority level is of lower priority than the first priority level.

17. The system of claim 15, wherein the reduction to the second rate limit is directly proportional to the reduction to the first rate limit.

18. The non-transitory computer readable medium of claim 15, wherein the second rate limit of the second rate limiter is reduced up to a first percentage threshold such that a non-zero rate of resource requests of the second priority level are processed.

19. The non-transitory computer readable medium of claim 18, wherein the first rate limit of the first rate limiter is reduced while the second rate limit is held constant at the first percentage threshold such that the resource request load no longer exceeds the resource request threshold.

20. The system of claim 18, wherein the second rate limit of the second rate limiter is reduced beyond the first percentage threshold where the first rate limit is reduced to a second percentage threshold and the request load exceeds the resource request threshold.
